(19) United States
(12) Patent Application Publication
(10) Pub. No.: US 2003/0074477 A1
(43) Pub. Date: Apr. 17, 2003

(54) System for determining medium to deliver document and determining method

(76) Inventors: Takafumi Fukushima, Fuji-shi (JP); Keizaburo Yamamoto, Sunto-gun (JP)

Correspondence Address: HARNESS, DICKEY & PIERCE, P.L.C., P.O. BOX 828, BLOOMFIELD HILLS, MI, 48303, US

(21) Appl. No.: 10/270,768

(22) Filed: Oct. 14, 2002

(30) Foreign Application Priority Data
Oct. 17, 2001 (JP) 2001-319495

(51) Int. Cl. G06F 15/16

(52) U.S. Cl. 709/246; 709/206

(57) ABSTRACT

The system for determining a medium to deliver a document, has a receiver section that receives electronic data of a document that includes an address and a name of each of a sender and a receiver, via a network, a memory section that stores a type of medium in which the receiver receives the document, a determining section that specifies the receiver from the electronic data received by the receiver section and determines a medium in which the receiver receives on the basis of the data stored in the memory section, a data generating section generates data in compliance with the medium determined by the determining section from the electronic data received, and a delivering section that converts the data generated by the data generating section into data in compliance with the medium to be received by the receiver and delivers it to the receiver.

### CROSS-REFERENCE TO RELATED APPLICATIONS

This application is based upon and claims the benefit of priority from the prior Japanese Patent Application No. 2001-319495, filed Oct. 17, 2001, the entire contents of which are incorporated herein by reference.

### BACKGROUND OF THE INVENTION

1. Field of the Invention

The present invention relates to a system of determining a medium for delivering a document created by a sender to a receiver, as well as its determining method.

2. Description of the Related Art

FIG. 10 illustrates a conventionally known system for delivering documents by accessing a network.

In this system, a person who wishes to send a mail operates a communication terminal 1 that is a personal computer or the like to connect it to a reception Web server 3 provided by some organization via the Internet 2.

After the connection has been established, the name and address of both of the sender and receiver are input in accordance with the instructions provided from the Web server 3, and then a document and/or an image are input. The input data are transmitted as an e-mail to the reception Web server 3. The reception Web server 3 receives the e-mail and stores it in a data memory section 4.

In the meantime, there is a public relations provider 5 that provides advertisements to organizations by a way of synthesizing an advertisement message to mails. Here, the public relations provider 5 accesses an advertisement production section 6 and creates advertisement data that fits to the usage of each user.

When advertisement data is created in the advertisement production section 6, the created advertisement data is synthesized by a document creating section 7 with an e-mail stored in the data memory section 4, and thus synthesized data is output to a post card printer 8.

The post card printer 9 prints out the synthesized data onto a post card 9. Here, the organization is supported to post the printed card 9 in a post office 10. In the postal office 10, the post card 9 thus posted is treated in a similar way to that of ordinary post cards, and the office staff delivers it to the receiver.

However, in the above-described system, the medium for receiving a mail is always limited to post cards, and therefore even if a receiver would like to receive it in the form of an e-mail, such a demand cannot be met. In other words, conventionally, mail receivers cannot select a medium in which they wish to receive mails.

Jpn. Pat. Appln. KOKAI Publication No. 10-133975 discloses a technique in which a person who does not have an e-mail address can send an e-mail to someone who has an e-mail address via a service provider. In this document, it is discussed that the service provider can mail an e-mail also in the form of a regular mail letter or post card, in addition to the e-mail itself, if a receiver wishes so. The document further describes that a person who has an e-mail address can send an e-mail message in the form of a regular letter of post card converting it from the e-mail at a service provider to a person who does not have an e-mail address.

In the above-described system, a mail receiver can select, to a certain degree, in which medium he or she wishes to receive a message. However, the system is not sufficient because a person who has an e-mail address must always send a message in the form of an e-mail. Further, when a receiver wishes to receive a message in the form of a letter or post card together with an e-mail, the message from the sender is automatically duplicated so that there are two versions, e-mail and postal mail for the massage and the sender would not even know that, which is not preferable in term of security.

### BRIEF SUMMARY OF THE INVENTION

In the field of the medium determining system for delivering a document, there has been a demand of improving the services for receivers by providing mail receivers surely with a right to select a medium in which they wishes to receive messages.

According to an aspect of the invention, there is provided a system for determining a medium to deliver a document. In this system, a receiver section receives electronic data of a document that includes a data item designating a sender and a receiver, via a network and a memory section stores a type of media in which the receiver receives the document. Further, a determining section specifies the receiver from the electronic data received by the receiver section and determines the type of medium in which the receiver receives on the basis of the data stored in the memory section. Further, a data generating section generates data in compliance with the medium determined by the determining section from the electronic data received, and a delivering section converts the data generated by the data generating section into data in compliance with the medium to be received by the receiver and delivers it to the receiver.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and comprise a part of the specification, illustrate embodiments of the invention, and together with the general description given above and the detailed description of the embodiments given below, serve to explain the principles of the invention.

FIG. 1 is a block diagram illustrating the first embodiment of the present invention;

FIG. 2 is a block diagram showing the detailed structure of a server system in the embodiment;

FIG. 3 is a diagram showing the structure of a user database in the embodiment;

FIG. 4 is a diagram showing the structure of a media register in the user database in the embodiment;

FIG. 5 is a flowchart illustrating a process of converting the format of a document by utilizing the media register of the embodiment;

FIG. 6 is a block diagram illustrating the second embodiment of the present invention;

FIG. 7 is a block diagram illustrating the third embodiment of the present invention;

FIG. 8 is a block diagram illustrating the fourth embodiment of the present invention;

FIG. 9 is a block diagram illustrating the fifth embodiment of the present invention; and

FIG. 10 is a block diagram illustrating a conventional technique.

### DETAILED DESCRIPTION OF THE INVENTION

Embodiments of the present invention will now be described in detail with reference to accompanying drawings.

(First Embodiment)

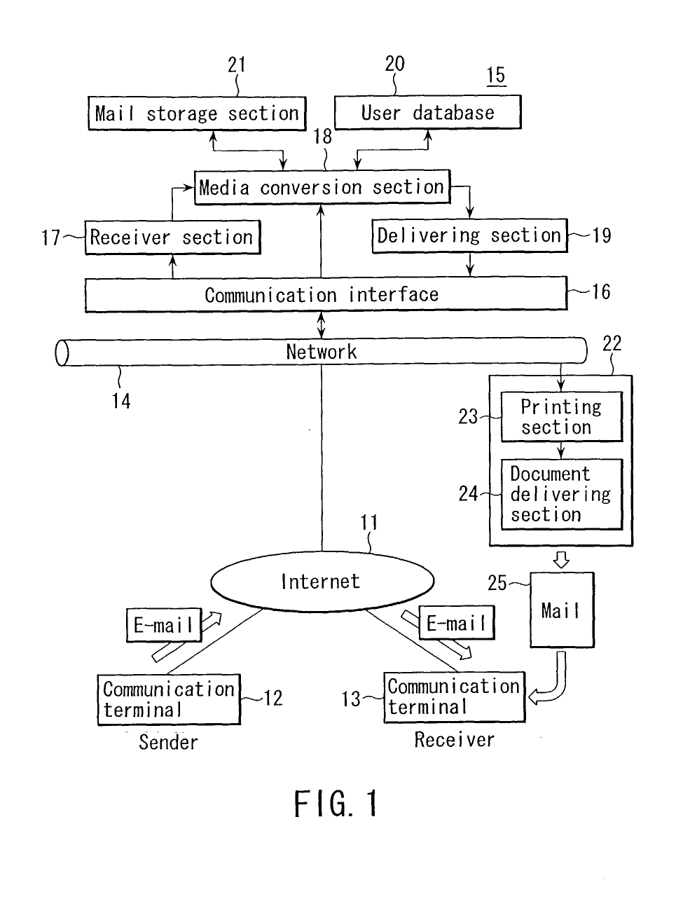

As shown in FIG. 1, as the network, the Internet 11 that is a network that uses, for example, an IP protocol is employed. To the Internet 11, a communication terminal 12 of a sender, which is, for example, a personal computer, and a communication terminal 13 of a receiver, which is, for example, a personal computer, are connected. It should be noted here that in this embodiment, the communication terminal 12 is fixed to the sender side, and the communication terminal 13 is fixed to the receiver side, but in practice, the communication terminals 12 and 13 can both serve as sender and receiver sides.

The Internet 11 is connected to a virtual private network 14 that has a high security and is capable of a high-speed processing. The network 14 is connected to a server system 15.

The server system 15 serves to connect a communication interface 16 to the network 14. To the communication interface 16, a receiver section 17, a media conversion section 18 and a delivering section 19 are connected.

The receiver section 17 receives e-mails from the communication terminal 12.

The media conversion section 18, which is connected also to the receiver section 17, carries out a process of registering to a user database 20, which medium a user of the system wishes to receive a document when he or she becomes a receiver. More specifically, data indicating a user wishes to receive a message in, for example, e-mail or in postal mail, is registered to the user database 20.

The media conversion section 18 identifies the sender and receiver from the e-mail received by the receiver section 17, and further receives, from the user database 20, data on which medium is wanted by the receiver when he or she receives a document. Then, based on the receives medium data, this section converts the bibliographic items of the document to the most appropriate format for the output medium, and stores the massage of the e-mail in a mail memory section 21. At the same time, the section stores the converted contents in the user database 20.

It should be noted that the registration and revision of a medium for receiving a document can be carried out by the user as he or she accesses the user database 20 by using the Internet 11 or a telephone line.

Other than the media data for a user to receive a document, the database 20 stores the address of the user, the delivering station nearest to the user, etc. Further, it saves the logs of correspondences between a sender and a receiver, so that a certification of delivery, a bill for services, etc. can be presented later to the users.

Further, the section can even function as an auxiliary section for preparing data to be used next time.

The media conversion section 18 generates the address, name, e-mail address, etc., the document, etc, on the basis of the medium designated by the receiver for receiving a document, and transfer these data to the delivering section 19.

When the receiver wishes to receive a document via e-mail, the delivering section 19 sets the e-mail address of the receiver as the destination and creates the e-mail. Then, the section 19 delivers the e-mail to the communication terminal 13 of the receiver via the network 14. On the other hand, when the receiver wishes to receive a document in postal mail, the delivering section 19 creates the bibliographical item data necessary for the postal mail and delivers it via the network 14 to the delivery station 22 that is located nearest to the receiver.

The delivery station 22 is equipped with a printing section 23 serving as a medium output section, and a document delivering section 24. By use of the printing section 23, the document, destination, etc., to be printed on a sheet such as a postal card are prepared on the basis of the bibliographical item data received from the delivering section 19, and they are printed on the sheet. The printed sheet is sent to the document delivering section 24 as a mail letter 25.

The document delivering section 24 sorts out thus received mail letters according to the area of delivery. A thus sorted mail letter 25 is delivered to the receiver by an office delivery person.

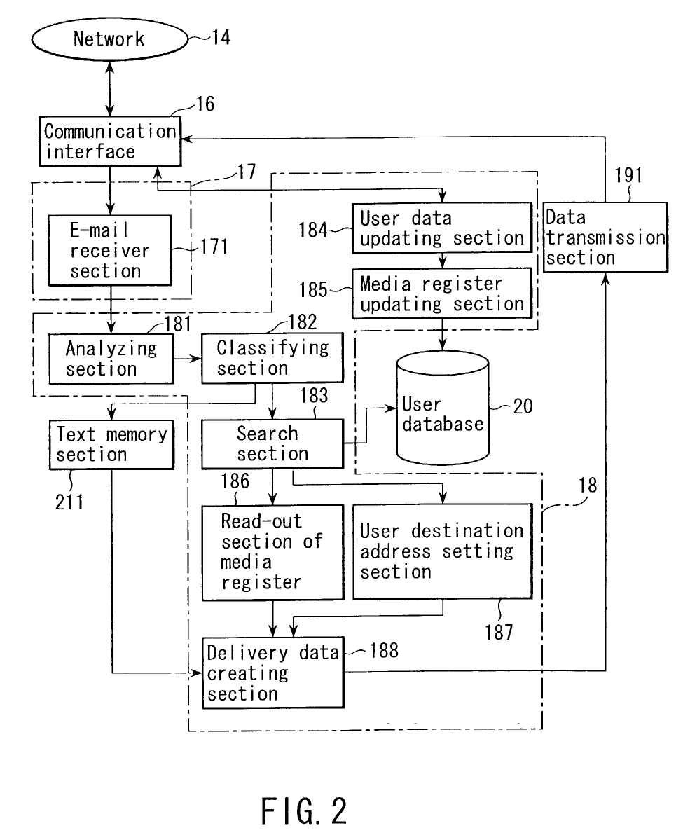

FIG. 2 is a block diagram illustrating a specific structure of the server system 15. The communication interface 16 serves to send and/or receive e-mails between the network 14 and itself.

The receiver section 17 is equipped with an e-mail receiver section 171, through which the communication interface 17 receives e-mails.

The medium conversion section 18 is equipped with an analyzing section 181, a classifying section 182, a search section 183, an updating section 184 for updating user data; a media register updating section 185, a read-out section 186 of a media register; a user destination address setting section 187 and a delivery data creating section 188.

In the media conversion section 18, the following processes take place. That is, an e-mail received by the e-mail receiver section 171 is analyzed if it is in such a format that can be interpreted by the system, and if it is of an interpretable format, the received e-mail is decoded by the classifying section 182 and then classified. Then, the main text of the e-mail classified by the classifying section 182 is stored in the text memory section 211 provided in the mail memory section 21.

The search section 183 searches the user database 20 based on the destination address classified by the classifying section 182 as a key, so as to obtain, from the database, the medium data designated by the receiver as to which medium he or she wishes to receive a document.

The user data updating section 184 accesses the media register of a media register section provided in the user database 20 via the media register updating section 185 on the basis of the media data for receiving the document, that is received via the communication interface 16. In other words, the updating section 184 serves to register the type of medium in the media register or revise it, thus updating the user data.

A read-out section 186 of the media register reads out the corresponding media data from the media register in the user database 20 via the search section 183, for confirmation.

The user destination address setting section 187 reads out the address or e-mail address of the appropriate receiver from the media register of the user database 20 via the search section 183, and then sets it as the destination address.

More specifically, in the case where the receiver wishes to receive the document in the form of an e-mail, the setting section 187 reads out its e-mail address and set it as the destination address. On the other hand, in the case where the receiver wishes to receive the document in the form of a regular mail letter, the setting section 187 reads out the ordinary postal address and set it as the destination address.

The delivery data creating section 188 creates the most appropriate data for the medium designated by the receiver and transfers it to a data transmission section 191 provided in the delivering section 19.

In the case of e-mail, the data transmission section 191 transmits the created data to the communication terminal 13 of the receiver from the communication interface 16 via the network 14. In the case of mail letter, the created data is transmitted to the delivery station 22 from the communication interface 16 via the network 14.

The media register of the user database 20 can be read or written by the users at any time. A user can access to the user data updating section 184 with use of the communication terminal 12 or 13 via the Internet 11, the network 14 and the communication interface 16, so as to monitor his or her registered data. Further, the user can rewrite the contents of the media register of the user database 20 through the media register updating section 185.

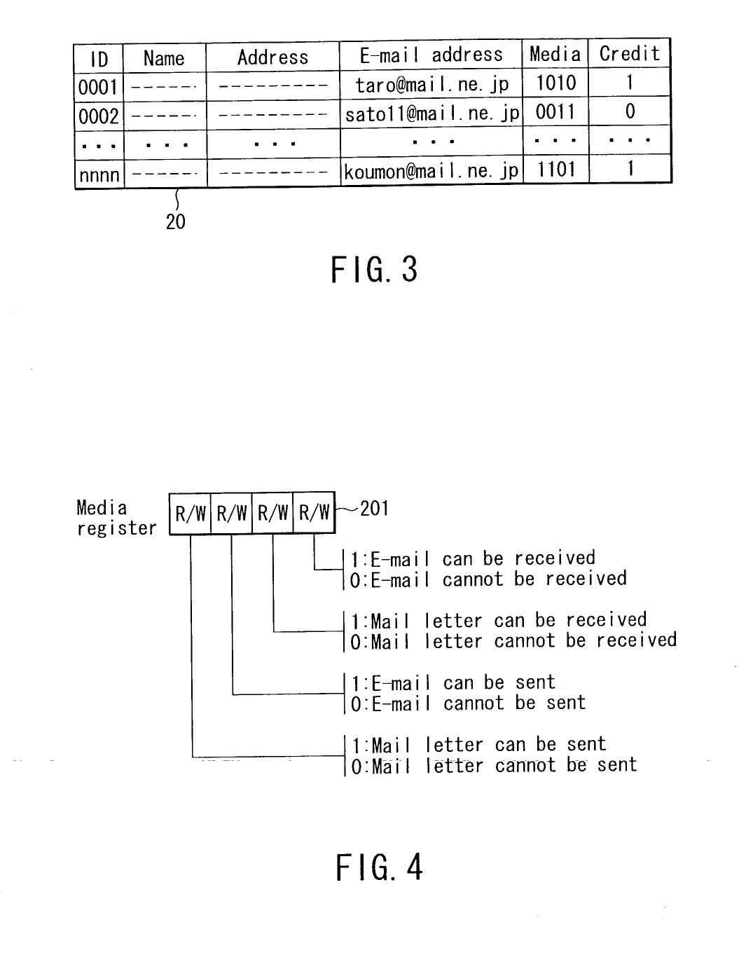

FIG. 3 illustrates a structure of the user database 20. The user database 20 has a memory section potion for each user, that stores the ID, name, address, e-mail address, a medium designated by the user, and the presence/absence of a credit. Of these memory portions, those used for storing media data make up the media register 201.

The media register 201 has, as shown in FIG. 4, a 4-bit structure, in which the first bit is used to store data indicating that an e-mail can be received, which is expressed by “1”, and data indicating that an e-mail cannot be received, which is expressed by “0”, the second bit is used to store data indicating that a mail letter can be received, which is expressed by “1”, and data indicating that a mail letter cannot be received, which is expressed by “0”, the third bit is used to store data indicating that an e-mail can be sent, which is expressed by “1”, and data indicating that an e-mail cannot be sent, which is expressed by “0”, and the fourth bit is used to store data indicating that a mail letter can be sent, which is expressed by “1”, and data indicating that a mail letter cannot be sent, which is expressed by “0”.

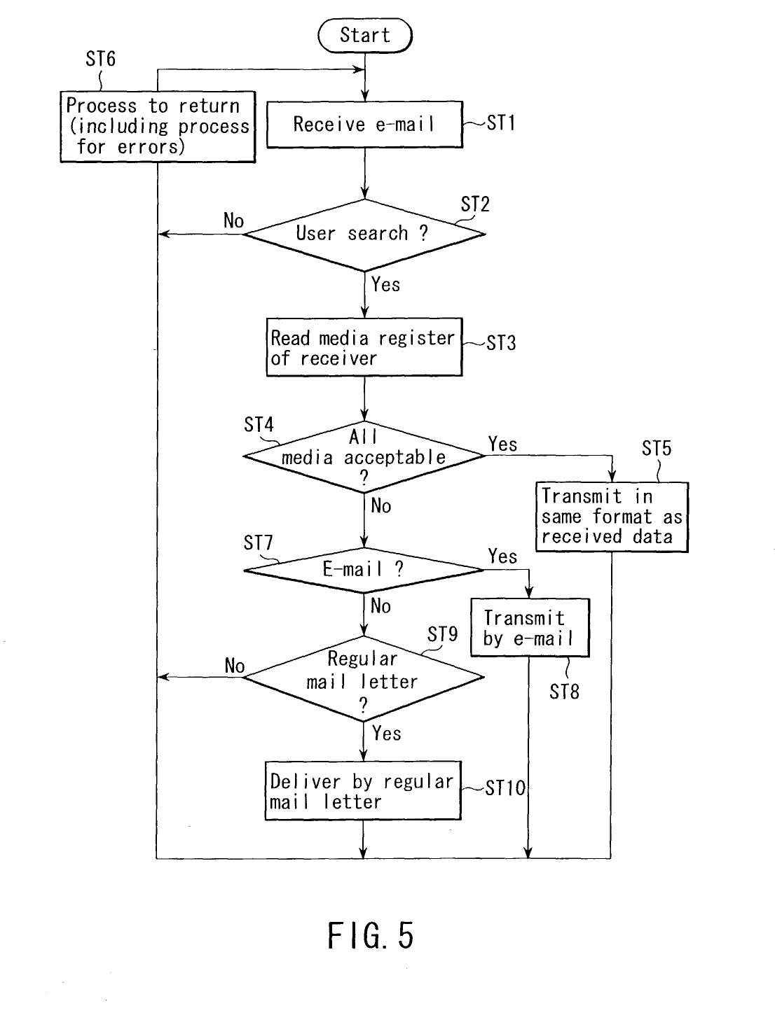

In the process of revising the format of a document by using the media register 201, first, the e-mail receiver section 171 receives the e-mail at ST1 as can be seen in FIG. 5.

Upon reception of the e-mail, the search section 183 searches the user database 20 to find the receiver at ST2. When the appropriate receiver is present and can be found, the read-out section 186 of the media register reads the media register 201 of the receiver at ST3.

At ST 4, it is determined whether or not all the media are possible. In other words, it is judged if both of e-mail and regular mail letter are possible as a medium received by the receiver.

If all the media are possible, the delivering section 19 sends the mail in the same format as that of the received data to the communication terminal 13 of the receiver at ST 5. In this case, the mail is transmitted in the form of an e-mail since the received data is in e-mail. Then, when the transmission is finished, the return process is carried out to return to the initial signal reception stand-by state at ST6.

If the e-mail is designated as the medium that the receiver wishes to receive documents, the designation of e-mail is recognized at ST7, and the delivering section 19 transmits the e-mail to the communication terminal 23 of the receiver at ST8. Then, when the transmission is finished, the return process is carried out to return to the initial signal reception stand-by state at ST6.

If the mail letter is designated as the medium that the receiver wishes to receive documents, the designation of the mail letter is recognized at ST9, and the delivering section 19 transmits the date of the letter me-mail to the communication terminal 23 of the receiver at ST10. Then, when the transmission is finished, the return process is carried out to return to the initial signal reception stand-by state at ST6.

On the other hand, in the case where the appropriate user cannot be found in the search of the user at ST2, the process for error is carried out at ST6 and then the status is returned to the initial signal reception stand-by state. On the other hand, even if the appropriate user is found, no media are assigned for receiving documents as being not possible, the process for error is carried out at ST6 and then the status is returned to the initial signal reception stand-by state.

In this system, when the sender transmits an e-mail from the communication terminal 12 to the receiver, the receiver section 17 receives the e-mail.

Subsequently, when the media conversion section 18 searches, on the basis of the address of the receiver provided in the e-mail, the user database 20 to find the appropriate receiver, and reads the type of medium that is designated by the receiver to receive documents, for confirmation.

The delivering section 19 creates the delivery data on the basis of the medium designated by the receiver. For example, when the medium designated by the receiver is e-mail, the delivering section 19 creates an e-mail, and sends the e-mail to the communication terminal 23 from the communication interface 16 via the network 14 and the Internet 11.

When the medium designated by the receiver is a mail letter, the delivering section 19 creates the mail letter data, and transmits the data from the communication interface 16 to the printing section 23 of the delivery station 22 via the network 14. In the delivery station 22, the printing section 23 creates the document and destination address, and prints them on a sheet such as a postal card. Thus printed sheet is sent as a mail letter 25 to the document delivering section 24. In the document delivering section 24, the mail is sorted, and then an office staff delivers the mail letter 25 to the receiver.

As described above, since the data regarding in which medium the receiver wishes to receive documents is preset in the user database 20, upon receiving an e-mail sent from a sender, the data can be created in the format of the medium in which the receiver wishes to receive documents on the basis of the data set in the user database 20, and thus created data can be delivered to the receiver in a desired medium. In other words, receivers surely have the selectivity to determine in which medium they wish to receive documents. In this manner, it is possible to improve service for the receivers.

On the other hand, when a receiver wishes to receive a document in the form of a regular mail letter, the mail data is transmitted to the delivery station 22, where the data is printed out immediately, and delivered to the receiver as a mail letter. In this manner, even when the receiver designate a mail letter as the medium in which he or she wishes to receive the document, the receiver can receive the postal material without delay.

Further, an e-mail received from a sender is delivered to the receiver in either one of e-mail or regular mail letter, and thus from one single e-mail, two documents, one in e-mail and the other in mail letter, will never be created. In other words, a document from the same sender will never be duplicated. In this manner, the confidential security of documents can be maintained.

(Second Embodiment)

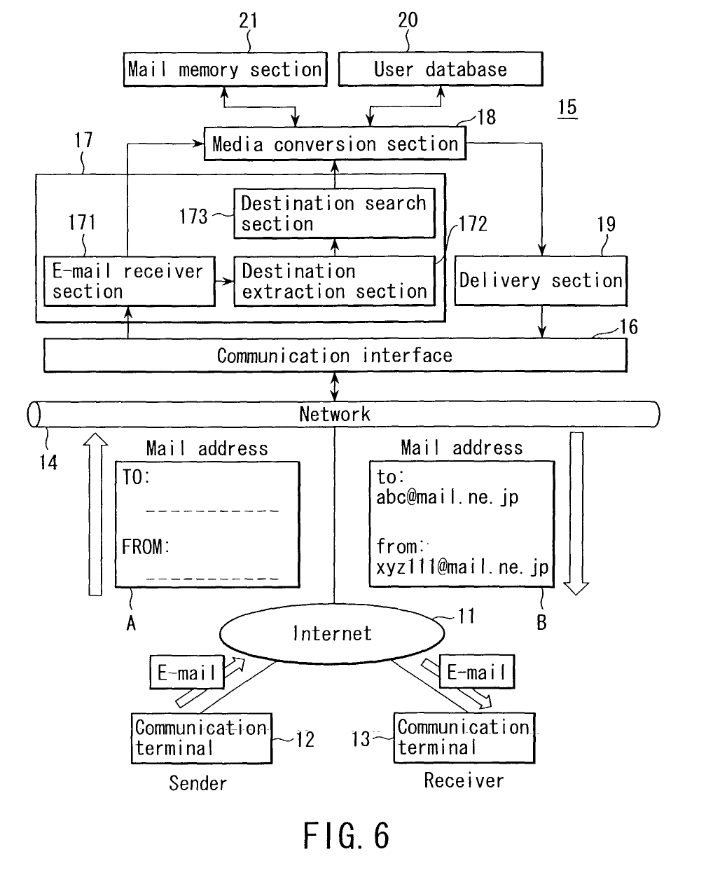

FIG. 6 shows the second embodiment of the present invention, in which the receiver section 17 of the server system 15 is provided with, in addition to the e-mail receiver section 171, a destination extraction section 172 that detects destination data including name and address from a received e-mail and stores it as a destination parameter, and a destination search section 173 that generates a trigger for creating the e-mail address of the receiver on the basis of the destination parameter stored in the destination extraction section 172.

The sender sends an e-mail A from the communication terminal 12 to the receiver, and he actually sends one with the terminal 12, he or she inputs the name and usual postal address of him or herself and those of the receiver into the e-mail A.

The e-mail A is received by the receiver section 17 of the server system 15, and the destination extraction section 172 extracts the name and address of the receiver from the e-mail and stores them as destination parameters.

The destination search section 173 outputs the stored destination parameters to the media conversion section 18. The media conversion section 18 searches the appropriate receiver out of the user database 20 based on the destination parameters as a key, and then extracts the e-mail address. Then, the address of the receiver is revised from the ordinary postal mail address to the e-mail address.

The text portion of the e-mail is temporarily stored in the mail memory section 21. Then, it is read out and transmitted to the delivering section 19 together with the e-mail address. The delivering section 19 creates an e-mail B from the e-mail address and the text, and transmits the e-mail B from the communication interface 16 to the communication terminal 13 of the receiver via the network 14 and the Internet 11.

As described above, a sender is not required to know the e-mail address of the receiver, and the e-mail address of the receiver can be automatically set by inputting the name and the ordinary postal address of the receiver. In this manner, without knowing the e-mail address of a receiver, the sender can send an e-mail to the receiver.

Thus, the receiver is free from a labor of informing his or her e-mail address to the sender, which is troublesome, and therefore service to the receivers can be improved. Further, a sender can transmit an e-mail even if he or she does not know the e-mail address of the receiver.

It should be noted here that the above description is made only in connection with the case where an e-mail is transmitted to a receiver; however in the case where the receiver designates a mail letter as the medium of receiving documents, mail letter data is created by the media conversion section 18 and the delivering section 19 and thus created data is transmitted to the delivery station as in the first embodiment.

In this embodiment, receivers surely have the selectivity to determine in which medium they wish to receive documents. Thus, it is possible to improve service for the receivers.

(Third Embodiment)

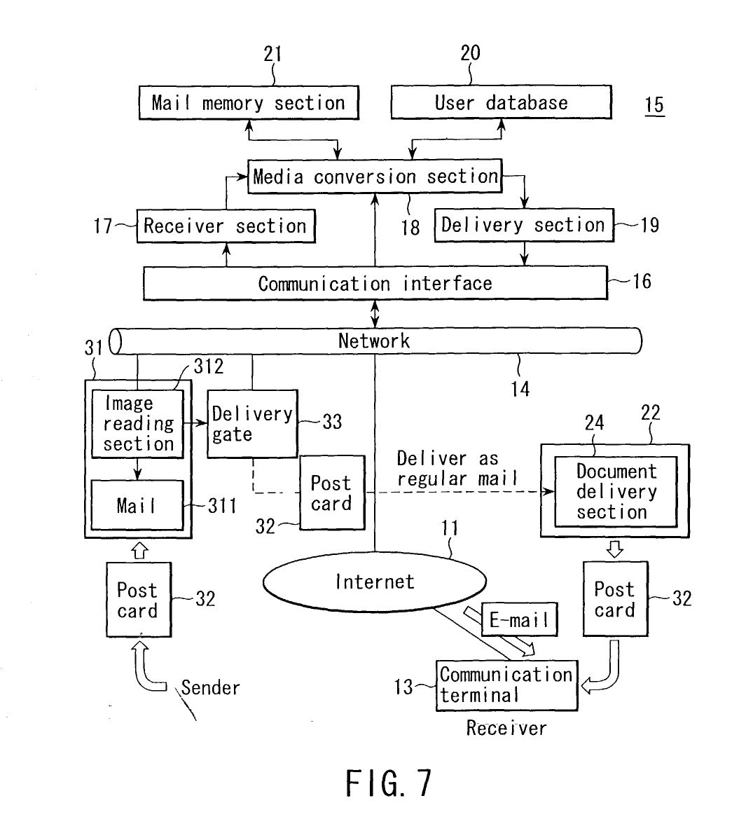

FIG. 7 shows the third embodiment of the present invention, which is equipped with a collection station 31. A sender drops a mail letter of a document written therein, that is, for example, a postal card 32 in the collection station 31. The collection station 31 is equipped with a mail reception section 311 and an image reading section 312.

The mail reception section 311 examines the destination address and size of the mailed post card 32. When the destination address is in order, and the size is of a predetermined one, the post card 32 is transferred to the image reading section 312. The image reading section 312 reads the bibliographic items including the document and destination from the postal card 32.

After reading the bibliographic items including the document and destination from the postal card 32, the collection station 31 inquires the server system 15 which medium is designated by the receiver to receive the document. If the medium of e-mail is designated by the receiver, the collection station 31 converts the bibliographic items read by the image reading section 312 into e-mail data, and transmits the data to the receiver section 17 of the server system 15 via the network 14. In this case, the remaining post card 32 is discarded or stored for a certain period of time.

On the other hand, if the medium of mail letter is designated by the receiver, a signal is given to a delivery gate 33 to deliver the mailed post card 32 as a mail to the delivery station 22. In the delivery station 22, post cards 32 received in the above-described manner are sorted out for delivery areas, respectively, by means of the document delivering section 24. Each post card 32 sorted as above is delivered by a delivery staff to the appropriate receiver.

Upon reception of electronic data, the receiver section 17 handles the electronic data in a similar manner to that of e-mails. The electronic data is transmitted to the media conversion section 18.

The media conversion section 18 analyzes the bibliographic items of the electronic data and determines the followings. That is, this section then reads the data of the appropriate receiver, that is, the address, name and e-mail address, from the user database 20, and then sets the e-mail address as its destination. Further, it sends the text as a mail text document to the delivering section 19.

The delivering section 19 creates an e-mail from the e-mail address and mail text, and transmits thus created e-mail from the communication interface 16 to the communication terminal 13 of the receiver via the network 14 and the Internet 11.

As described above, even if a sender does not have a communication terminal to transmit e-mails, the send can send a document to the receiver by dropping the mail such as post card in the collection station 31, and the receiver can receive it by way of a mail letter or e-mail.

Thus, in this embodiment, receivers surely have the selectivity to determine in which medium they wish to receive documents. In this manner, it is possible to improve service for the receivers.

(Fourth Embodiment)

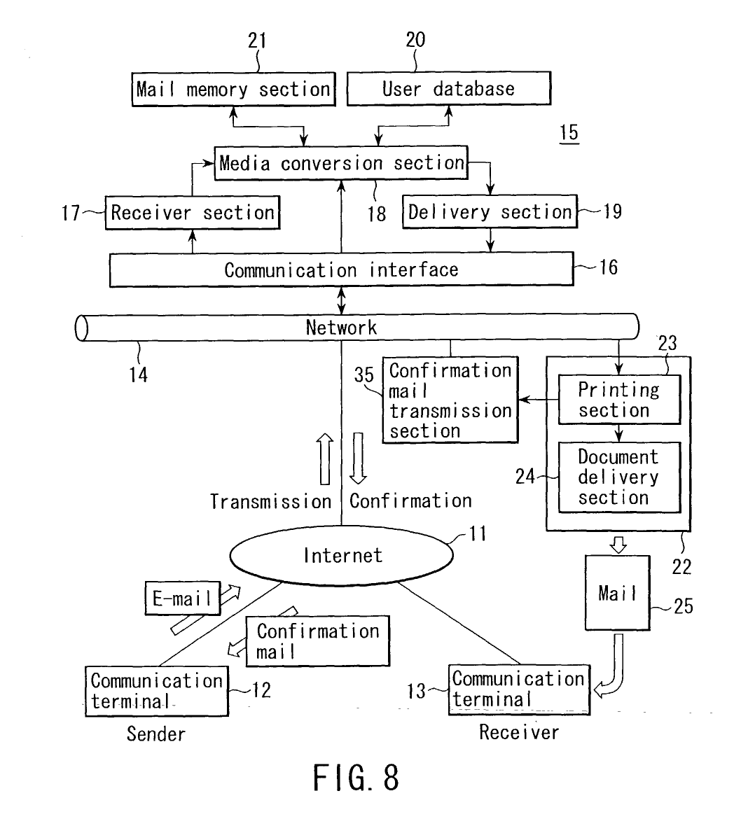

FIG. 8 illustrates the fourth embodiment, which is equipped with a confirmation mail transmitting section 35 connected to the network 14.

When the printing section 23 of the delivery station 22 prints out a document, destination, etc. to be printed on a sheet such as post card, on the basis of the bibliographic item data received from the delivering section 19, the confirmation mail transmitting section 35 automatically creates a confirmation mail added with a numeral or symbol unique to the process for the mail. Then, thus created confirmation mail is transmitted to the communication terminal 12 of the sender via the network 14 and the Internet 11.

When a sender transmits e-mail to a receiver via the communication terminal 12, the receiver section 17 receives this mail. The media conversion section 18 searches, on the basis of the address of the receiver provided in the e-mail, the user database 20 to find the appropriate receiver, and reads the type of medium that is designated by the receiver to receive documents, for confirmation. Then, the delivering section 19 creates the delivery data on the basis of the medium which has been confirmed that it is designated by the receiver.

Here, for example, when the medium designated by the receiver is e-mail, the media conversion section 18 creates delivery data for the e-mail, and sends the data to the delivering section 19. The delivering section 19 creates the e-mail from the received delivery data, and transmits it to the communication terminal 13 from the communication interface 16 via the network 14 and the Internet 11.

When the medium designated by the receiver is a mail letter, the delivering section 19 creates delivery data for the mail letter, and transmits the data to the delivering section 19. The delivering section 19 creates the mail data from the received delivery data, and transmits the data from the communication interface 16 to the printing section 23 of the delivery station 22 via the network 14.

The printing section 23 creates the document and destination address, and prints them on a sheet such as a postal card. Thus printed sheet is sent as a mail letter 25 to the document delivering section 24. In the document delivering section 24, the mail is sorted, and then an office staff delivers the mail letter 25 to the receiver.

When the printing section 23 carries out printing, the confirmation mail transmitting section 35 creates a confirmation mail added with a numeral or symbol unique to the process for the mail. Then, thus created confirmation mail is transmitted to the communication terminal 12 of the sender via the network 14 and the Internet 11.

As described above, when the content transmitted in the form of an e-mail from the sender are delivered to the receiver in the form of a regular mail letter, a confirmation mail is transmitted to the sender. In this manner, the sender can confirm that the e-mail has been delivered to the receiver in the form of a mail letter.

Further, the sender is at this point aware of the fact that the transmitted e-mail has been transformed into a mail letter, whose confidentiality and security level is lower than that of the e-mail, and is able to be prepared for unexpected troubles that might occur.

Further, by adding a unique numeral to the confirmation mail, it is possible to keep a record of the delivery. Further, the unique number assigned to each confirmation mail can be utilized for, for example, lottery, or the collection of the fee or discounting of the fee. Thus, the unique number assigned to a confirmation mail can be applied for a variety of services.

Thus, in this embodiment, receivers surely have the selectivity to determine in which medium they wish to receive documents. In this manner, it is possible to improve service for the receivers.

(Fifth Embodiment)

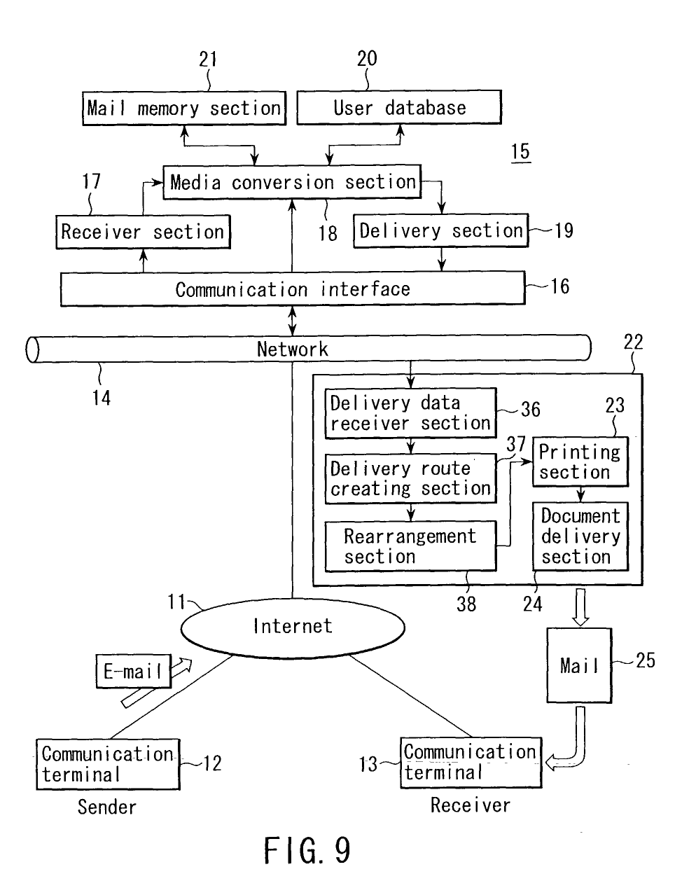

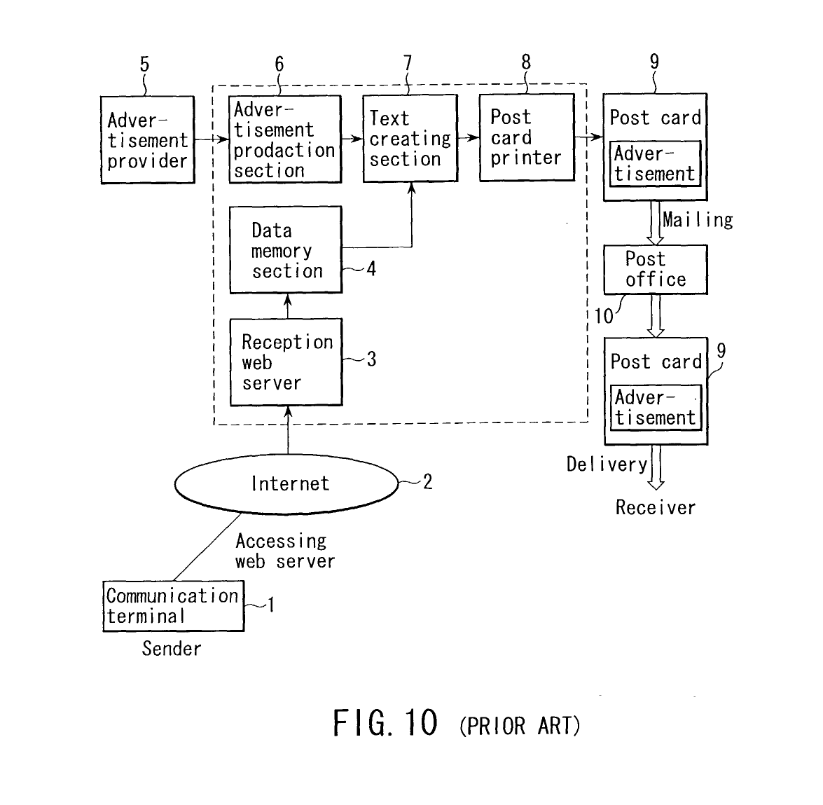

FIG. 9 illustrates the fifth embodiment, which is equipped with, in addition to the printing section 23 and the document delivering section 24, a delivery data receiver section 36, a delivery route creating section 37 and a rearrangement section 38.

The delivery data receiver section 36 receives a plurality of sets of bibliographical item data for creating mail letters from the delivering section 19 and temporarily store them until the subsequent delivery preparation time comes.

When it is time for the delivery preparation, the delivery route creating section 37 reads a plurality of bibliographical item data stored in the delivery data receiver section 36, and calculates out the optimal delivery route from the addresses of the destinations of the mails to create a delivery routing pathway.

The rearrangement section 38 rearranges the received bibliographic item data in accordance with the routing pathway created by the delivery route creating section 37, and outputs the rearranged data to the printing section 23. The printing section 23 prints out mail letters successively by the order of the bibliographic item data input in order.

In this system, the delivery station 22 receives bibliographic item data from the delivering section 19 of the server system 15 and stores these data temporarily in the delivery data receiver section 36.

When the delivery preparation time comes, the delivery route creating section 37 reads the bibliographic item data from the delivery data receiver section 36. Here, it should be noted that the delivery data receiver section 36 stores these bibliographic item data in the order that they are received.

Then, the delivery route creating section 37 calculates out the optimal delivery route from the addresses of the destinations provided in these bibliographical item data, and then creates a delivery pathway route. The rearrangement section 38 rearranges the data order in accordance with the routing pathway thus created, and outputs the rearranged data to the printing section 23.

The printing section 23 prints out the data in the order of the bibliographic item data transmitted from the rearrangement section 38, and thus creates mail letters 25, which are transferred to the document delivery section 24.

In this manner, the printed mail letters 25 are arranged in the order of the optimal delivery route, and therefore there will be no more necessary to sort the mails for respective delivery areas by the document delivery section 24. Therefore, there is no need to install a large-scale facility to sort mail letters in the document delivering section 24, and it becomes possible even for a small delivery office to handle mails.

The above-described system results in substantial labor savings and improvement of the delivery efficiency. Therefore, it becomes possible to deliver mails to the user more quickly than usual. In addition, it becomes possible to reduce the cost of the delivery.

In this embodiment as well, receivers surely have the selectivity to determine in which medium they wish to receive documents. In this manner, it is possible to improve service for the receivers.

It should be noted that the above-described embodiments are described in connection with the case where an e-mail is received from a sender; however the present invention is not limited to the case of e-mail, but it can be applied to electronic data that does not even have a mail format. However, in this case also, the electronic data must contain the name and address of both the sender and receiver.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for determining a medium to deliver a document, comprising:
a receiver section configured to receive electronic data of a document that includes a data item designating a sender and a receiver, via a network;
a memory section that stores a type of medium in which the receiver receives the document;
a determining section configured to specify the receiver from the electronic data received by the receiver section and determine a medium in which the receiver receives on the basis of the data stored in the memory section;
a data generating section configured to generate data in compliance with the medium determined by the determining section from the electronic data received; and
a delivering section configured to convert the data generated by the data generating section into data in compliance with the medium to be received by the receiver and deliver it to the receiver.

2. A system for determining a medium to deliver a document, according to claim 1, wherein the electronic data received by the receiver section is an e-mail.

3. A system for determining a medium to deliver a document, according to claim 1, further comprising an updating section configured to register a medium for a user to receive a document and updates it when necessary via the network.

4. A system for determining a medium to deliver a document, according to claim 1, further comprising a printing section for creating a mail letter from the delivery data delivered by the delivering section.

5. A system for determining a medium to deliver a document, according to claim 1, wherein the memory section stores an address and e-mail address of a receiver and further comprises a conversion section configured to convert, when the address of the receiver is provided in the e-mail received by the receiver section, the address into an e-mail address of an e-mail format, on the basis of the data stored in the memory section, and the delivering section creates an e-mail whose address of the receiver is converted into the mail address of the e-mail format, and delivers it to the receiver.

6. A system for determining a medium to deliver a document, according to claim 1, further comprising a collection station configured to inputting a document of a mail letter dropped in the station as an image, converts the image data into electronic data, and outputs it to the receiver section.

7. A system for determining a medium to deliver a document, according to claim 1, wherein the delivering section creates an e-mail added with a mail address of an e-mail format when it is judged by the determining section that the medium to be received by the receiver is an e-mail, and delivers the e-mail to the receiver.

8. A system for determining a medium to deliver a document, according to claim 4, further comprising a transmission section configured to transmit a confirmation mail to the sender, the transmission section transmitting the confirmation mail to the sender to inform the electronic data received was transformed into a mail letter, when the printing section finishes the creation of the mail letter.

9. A system for determining a medium to deliver a document, according to claim 4, wherein the memory section further stores an address of a receiver, and further comprises:
a distribution data receiver section configured to store addresses of a plurality of receivers read out from the memory portion together with corresponding documents, as delivery data;
a route creating section configured to create an optimal route pathway for delivery on the basis of the addresses of the receivers stored in the delivery data receiver section; and
a rearrangement section configured to rearrange a printing order of the delivery data in accordance with the route pathway created by the route creating section;
and the printing section prints out the delivery data by the printing order rearranged by the rearrangement section, and thus creates mail letters.

10. A method for determining a medium to deliver a document, comprising:
receiving electronic data of a document that includes a data item designating a sender and a receiver, via a network;
specifying the receiver from the electronic data received by the receiver section and determining a medium in which the receiver receives on the basis of the data stored in a memory section;
generating delivery data in compliance with the medium determined with the electronic data received; and
delivering the created delivery data in compliance with the medium to be received by the receiver.
